(19) United States
(12) Patent Application Publication
(10) Pub. No.: US 2016/0006011 A1
(43) Pub. Date: Jan. 7, 2016

(54) HEAT-RESISTANT POROUS SEPARATOR AND METHOD FOR MANUFACTURING THE SAME

(71) Applicant: BenQ Materials Corporation, Taoyuan City (TW)

(72) Inventor: Hsin-Wei CHEN, Taoyuan City (TW)

(21) Appl. No.: 14/746,824

(22) Filed: Jun. 22, 2015

(30) Foreign Application Priority Data
Jul. 3, 2014 (TW) 103123007

(51) Int. Cl. H01M 2/16; H01M 2/14

(52) U.S. Cl. CPC H01M 2/1686; H01M 2/1646; H01M 2/1653; H01M 2/145

(57) ABSTRACT

The present disclosure provides a heat-resistant porous separator. The heat-resistant porous separator includes a porous substrate and a composite coating layer coated on at least one surface of the substrate. The composite coating layer is an interpenetrating polymer network structure formed by a hydrophilic polymer and silicon dioxide. A method for manufacturing a heat-resistant porous separator is also provided herein.

### CROSS-REFERENCE TO RELATED APPLICATION

This application claims the priority benefit of Taiwanese application serial no. 103123007, filed on Jul. 3, 2014, the full disclosure of which is incorporated herein by reference.

### BACKGROUND

1. Technical Field

The present invention relates to a heat-resistant porous separator and a method for manufacturing the same. More particularly, the heat-resistant porous separator is used in the lithium-ion battery.

2. Description of Related Art

A separator is a kind of polymeric thin film which is interposed between the positive electrode and the negative electrode in a lithium-ion battery to prevent the short circuits caused by physical contact of the two electrodes. In the meantime, the microporous structure of the separator permits free ions transporting within the cell and thus to generate voltage. However, a dimensional shrinkage of the separator will occur when the temperature of the cell is increased due to poor heat resistance of the separator, such that the electrodes will directly contact to cause the internal short circuits.

For improving the heat resistance of the separator, the current manufacturing method predominantly provides a heat-resistant coating layer including inorganic particles and adhesives on the separator. However, in this method, inorganic particles in the coating layer are easily shedded from the separator and then fall into the cell, thus resulting in the safety problem of the battery.

Moreover, since the inorganic particles sizes are larger than the pore size of the separator, they are binded on the surface of the separator for slowing down the speed of heat transfer. However, when the heat is transferred to the separator, the shrinkage of the separator is still occurred to induce circuit shortage.

On other hand, the separator is almost made of non-polar polyolefin material but the electrolyte is polar. The different polarity of the separator and the electrolyte leads to poor electrolyte absorption ability, thus resulting in low ion conductivity and low battery efficiency. Although, in the current method of coating inorganic particles on the separator surface aforementioned, capillarity generated by the particles aggregation can increase electrolyte absorption, the absorbing amount of the electrolyte is extremely limited.

### SUMMARY

According to aforementioned reasons, the present invention provides a novel heat-resistant porous separator with excellent heat resistance and high electrolyte absorption ability. The heat-resistant porous separator comprises a porous substrate and a composite coating layer. The composite coating layer is an interpenetrating polymer network structure formed by a hydrophilic polymer and silicon dioxide.

The present invention also provides a novel method for manufacturing a heat-resistant porous separator including a porous substrate and a composite coating layer. In the composite coating layer, an interpenetrating polymer network structure is formed by the hydrophilic polymer and silicon dioxide.

When the internal temperature in batteries rises up, the silicon dioxide with network structure in the composite coating layer can inhibit the thermal shrinkage and avoid meltdown or rupture of the separator. The hydrophilic polymer in the composite coating layer can enhance the surface hydrophilic properties of the separator so as to increase electrolyte absorption ability, decrease the internal resistance of batteries and enhance battery performance. In the meantime, the hydrophilic polymer also provides good flexibility of composite coating layer thus to avoid crack occurred on the surface thereof.

The heat-resistant porous separator of the present invention comprises a porous substrate and a composite coating layer which is coated on at least one surface of the porous substrate. The composite coating layer is an interpenetrating polymer network structure formed by a hydrophilic polymer and silicon dioxide.

According to an aspect of the present invention, the porous substrate is made from high density polyethylene, polypropylene, polyvinyl chloride, polyvinyl fluoride, polyester, polyamide or a combination thereof.

According to an aspect of the present invention, the silicon dioxide in the composite layer is formed through hydrolysis and condensation reactions of silicon dioxide precursor.

According to an aspect of the present invention, the weight ratio of the hydrophilic polymer and the silicon dioxide precursor is in the range of 0.008 to 1.5.

According to an aspect of the present invention, the hydrophilic polymer is selected from the group consisting of ethylene vinyl-alcohol copolymer, polyvinyl alcohol and a combination thereof.

According to an aspect of the present invention, the composite coating layer further comprises a dispersant.

According to an aspect of the present invention, the dispersant is selected from the group consisting of 3-glycidyloxypropyltrimethoxysilane, 3-aminopropyltriethoxysilane, methacryloyl propyltrimethoxysilane, vinyltrimethoxysilane and a combination thereof.

The present invention also provides a method for manufacturing a heat-resistant porous separator including steps of providing a porous substrate; adding 0.2 to 1.5 parts by weight of a hydrophilic polymer into 90 to 98 parts by weight of a solvent to form a reaction solution; mixing 1 to 25 parts by weight of a silicon dioxide precursor into the reaction solution to form a mixed solution; adding an aqueous hydrochloric acid solution into the mixed solution to conduct hydrolysis and condensation reactions of the silicon dioxide precursor to form a clear solution; coating the clear solution on at least one surface of the porous substrate to form a composite coating layer; and drying the porous substrate with the composite coating layer thereon to form a heat-resistant porous separator.

According to an aspect of the present invention, in the method for manufacturing the heat-resistant porous separator, the hydrophilic polymer is selected from the group consisting of ethylene vinyl-alcohol copolymer, polyvinyl alcohol and a combination thereof.

According to an aspect of the present invention, in the method for manufacturing the heat-resistant porous separator, the solvent is selected from the group consisting of water, ethanol, isopropanol, methanol and a combination thereof.

According to an aspect of the present invention, in the method for manufacturing the heat-resistant porous separator, the silicon dioxide precursor is selected from the group consisting of tetraethoxy silane, tetramethoxy silane, trimethoxy silane and a combination thereof.

According to an aspect of the present invention, in the method for manufacturing the heat-resistant porous separator, the porous substrate is made from high density polyethylene, polypropylene, polyvinyl chloride, polyvinyl fluoride, polyester, polyamide or a combination thereof.

According to an aspect of the present invention, in the method for manufacturing the heat-resistant porous separator, before the step of providing an aqueous hydrochloric acid solution into the mixed solution, further comprises a step of adding a dispersant into the mixed solution.

According to an aspect of the present invention, in the method of manufacturing the heat-resistant porous separator, the dispersant is selected from the group consisting of 3-aminopropyltriethoxysilane, methacryloyl propyltrimethoxysilane vinyltrimethoxysilane, 3-glycidyloxypropyltrimethoxysilane, and a combination thereof.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

The heat-resistant porous separator of the present invention comprises a porous substrate and a composite coating layer which is coated on at least one surface of the porous substrate. The composite coating layer is an interpenetrating polymer network structure formed by a hydrophilic polymer and silicon dioxide.

In the heat-resistant porous separator, the porous substrate is made from high density polyethylene, polypropylene, polyvinyl chloride, polyvinyl fluoride, polyester, polyamide or a combination thereof.

In a preferred embodiment of the present invention, the porous substrate is made from polypropylene. The film thickness of the porous substrate is 20 um and the porosity thereof is 45%.

In the heat-resistant porous separator, silicon dioxide in the composite coating layer is formed through hydrolysis and condensation reactions of a silicon dioxide precursor.

In an embodiment of the present invention, the weight ratio of the hydrophilic polymer and the silicon dioxide precursor is in the range of 0.008 to 1.5, preferably in the range of 0.01 to 0.6. If the ratio is less than the recommended limit, the crack will be occurred on the composite coating layer and the separator surface becomes more hydrophobic so as to decrease electrolyte absorption ability. If the ratio is higher than the recommended limit, the heat resistance of the separator will be poor so as to influence the thermal shrinkage performance of the heat-resistant porous separator.

In the heat-resistant porous separator, the hydrophilic polymer is selected from the group consisting of ethylene vinyl-alcohol copolymer, polyvinyl alcohol and a combination thereof.

In a preferred embodiment of the present invention, the hydrophilic polymer is ethylene vinyl-alcohol copolymer and the weight average molecular weight thereof is in the range of 10,000 to 500,000. If the weight average molecular weight thereof is too large, the pores in the separator will be blocked by the hydrophilic polymer more easily. If the weight average molecular weight thereof is too small, the composite coating layer will be likely separated from the separator.

In the heat-resistant porous separator, the composite coating layer further comprises a dispersant. The dispersant is used to improve the dispersion uniformity between the hydrophilic polymer and the silicon oxide in the composite coating layer. For example, the dispersant is selected from the group consisting of 3-glycidyloxypropyltrimethoxysilane, methacryloyl propyltrimethoxysilane, vinyltrimethoxysilane, 3-aminopropyltriethoxysilane, and a combination thereof. In a preferred embodiment of the present invention, the dispersant is 3-glycidyloxypropyltrimethoxysilane.

Thus, the dispersant used in the composite coating layer is in the 15 to 25 parts by weight based on 100 parts by total weight of the silicon oxide precursor and the hydrophilic polymer.

In addition, the present invention also provides a method for manufacturing a heat-resistant porous separator including the steps of providing a porous substrate; adding 0.2 to 1.5 parts by weight of a hydrophilic polymer into 90 to 98 parts by weight of a solvent to form a reaction solution; mixing 1 to 25 parts by weight of a silicon dioxide precursor into the reaction solution to form a mixed solution; adding an aqueous hydrochloric acid solution into the mixed solution to conduct hydrolysis and condensation reactions to form a clear solution; coating the clear solution on at least one surface of the porous substrate to form a composite coating layer; and drying the porous substrate with the composite coating layer thereon to form the heat-resistant porous separator.

In the method for manufacturing a heat-resistant porous separator of the present invention, in the step of adding an aqueous hydrochloric acid solution into the mixed solution, the network structure of silicone dioxide is formed by silicon dioxide precursor through hydrolysis and condensation reactions. When the clear solution in obtained, it means that the network structure of silicone dioxide is formed completely.

In an embodiment of the present invention, the weight percent concentration of the aqueous hydrochloric acid solution is about 37%. However, the weight percent concentration thereof is not limited.

In the method for manufacturing a heat-resistant porous separator of the present invention, if the solvent, silicon dioxide precursor and aqueous hydrochloric acid solution is used in an amount below or higher than the recommended range aforementioned, the silicon dioxide precursor will only form silicon dioxide particles, not a network structure.

Moreover, for enhancing the hydrophilic properties of the separator so as to increase electrolyte absorption ability, the hydrophilic polymer is applied to form the composite coating layer.

In the method for manufacturing a heat-resistant porous separator of the present invention, the composite coating layer composed of the interpenetrating polymer network formed by the hydrophilic polymer and silicon dioxide could make the porous separator have excellent heat resistance, hydrophilic property and good flexibility.

Thus, in a preferred embodiment of the present invention, the hydrophilic polymer is in the 0.2 to 1.5 parts by weight, the solvent is in the 90 to 98 parts by weight and the silicon dioxide precursor is in the 2.8 to 18 parts by weight.

In the method for manufacturing a heat-resistant porous separator of the present invention, the porous substrate is made from high density polyethylene, polypropylene, polyvinyl chloride, polyvinyl fluoride, polyester, polyamide or a combination thereof. In a preferred embodiment of the present invention, the porous substrate is made from polypropylene. The thickness of the porous substrate is 20 um and the porosity thereof is 45%.

In the method for manufacturing a heat-resistant porous separator of the present invention, the hydrophilic polymer is selected from the group consisting of ethylene vinyl-alcohol copolymer, polyvinyl alcohol and a combination thereof. In a preferred embodiment of the present invention, the hydrophilic polymer is ethylene vinyl-alcohol copolymer and the weight average molecular weight thereof is in the range of 10,000 to 500,000.

In the method for manufacturing a heat-resistant porous separator of the present invention, the solvent is selected from the group consisting of water, alcohol, isopropanol, methanol and a combination thereof.

In the method for manufacturing a heat-resistant porous separator of the present invention, the silicon dioxide precursor is selected from the group consisting of tetraethoxy silane, tetramethoxy silane, trimethoxy silane and a combination thereof.

In the method for manufacturing a heat-resistant porous separator of the present invention, before the step of providing a aqueous hydrochloric acid solution into the mixed solution, further comprises a step of adding a dispersant into the mixed solution.

In an embodiment of the present invention, the dispersant is selected from the group consisting of 3-aminopropyltriethoxysilane, methacryloyl propyltrimethoxysilane vinyltrimethoxysilane, 3-glycidyloxypropyltrimethoxysilane, and a combination thereof.

The dispersant used in the composite coating layer is in the 15 to 25 parts by weight based on 100 parts by weight of the silicon oxide precursor and the hydrophilic polymer. In a preferred embodiment of the present invention, the dispersant is 3-glycidyloxypropyltrimethoxysilane.

In the method for manufacturing a heat-resistant porous separator of the present invention, the coating method is known to the person skilled in the art, such as dip coating, slit coating, slot-die coating, roller coating, spin coating or intermittent coating, but not limited thereto.

In the method for manufacturing a heat-resistant porous separator of the present invention, the drying condition is at 60° C. to 120° C. for 0.5 to 10 minutes. In a preferred embodiment, the drying condition is 80° C. for 3 minutes.

In final, the properties of the porous separator of the present invention are measured according the following measuring method. The measurement results are listed in the table 3.

Measurement the Air Permeability of the Porous Separator

The time that 10 cc air permeates the separator sample with 1 square inch was measured using a Gurley permeability tester according to ASTM D-726. A low Gurley value means that the separator has high air permeability.

Measurement of the Thermal Shrinkage Ratio of the Porous Separator

The separator was cut into a sample size of 10 cm×10 cm. Firstly, the original length L1 in the machine direction (MD) of the sample is measured. Then, the sample is disposed into the oven at 150° C. for 1 hours. After the sample was heated, the length L2 in the machine direction of the sample is measured. The thermal shrinkage ratio is defined as (L2−L1)/L1×100%.

Measurement of Surface Energy of the Porous Separator

Different dyne level testing pens are used to measure the surface energy of the porous separator. When the dyne testing pen is applied to the surface, the ink of the testing pen will either form a continuous line or draw back into small droplets on the surface. When the ink forms a continuous line on the surface for two seconds, it represents that the surface energy of the separator is higher than the dyne level of the dyne testing pen. Then, the next higher dyne level pen is applied to repeat the measurement.

If the ink forms small droplets in less than two seconds, it means the surface energy of the separator is lower than that dyne level of the dyne testing pen. Thus, the surface energy of the porous separator is equal to the lower one dyne level of the dyne testing pen.

When the lower surface energy of porous separator is obtained, it means the porous separator has poor wetting characteristic so that the surface thereof is to be more hydrophobic. Otherwise, when the higher surface energy of porous separator is obtained, it means the porous separator has good wetting characteristic so that the surface thereof is to be more hydrophilic.

The present invention will be explained in further detail with reference to the examples. However, the present invention is not limited to these examples.

The preparation method of a heat-resistant porous separator

### Example 1

0.5 parts by weight of ethylene vinyl-alcohol copolymer (trade name 414077, ethylene content is 27 mole % and is available from Sigma-Aldrich, US) was added into 95 parts by weight of solvent consisted of 60 wt % of ethanol and 40 wt % of water to form a reaction solution. Then, the reaction was heated to 95° C. for 2 hours until the clear solution was obtained. After that, the clear solution was cooled down to room temperature. Next, 9 parts by weight of tetraethoxy silane and the clear solution were mixed uniformly, then, 0.2 parts by weight of 37% aqueous hydrochloric acid solution were added thereinto to conduct hydrolysis and condensation reactions for 1 hr to form a clear coating solution. Finally, the coating solution was coated on both surface of the polypropylene porous film (trade name D120D, the film thickness is 20 um and is available from BenQmaterials, Taiwan) to form two separate composite coating layers thereon. In final, the polypropylene porous film and the composite coating layers thereon are dried in the oven at 80° C. for 3 minutes to obtain a heat-resistant porous separator.

### Example 2

The preparation method of Example 2 is the same as Example 1, except that the amount of vinyl-alcohol copolymer, tetraethoxy silane and solvent. The detailed composition of Example 2 is listed in Table 1 below.

### Example 3

The preparation method of Example 3 is the same as Example 1, except that the amount of vinyl-alcohol copolymer, tetraethoxy silane and solvent. The detailed composition of Example 3 is listed in Table 1 below.

### Example 4

The preparation method of Example 4 is the same as Example 1, except that the amount of vinyl-alcohol copolymer, tetraethoxy silane and solvent. The detailed composition of Example 4 is listed in Table 1 below.

### Example 5

The preparation method of Example 5 is the same as Example 1, except that the amount of vinyl-alcohol copolymer, tetraethoxy silane and solvent. The detailed composition of Example 5 is listed in Table 1 below.

### Example 6

The preparation method of Example 6 is the same as Example 1, except that the amount of vinyl-alcohol copolymer, tetraethoxy silane and solvent. The detailed composition of Example 6 is listed in Table 2 below.

### Example 7

The preparation method of Example 7 is the same as Example 1, except that the amount of vinyl-alcohol copolymer, tetraethoxy silane, solvent. and coating types. The detailed composition of Example 7 is listed in Table 2 below.

### Example 8

The preparation method of Example 8 is the same as Example 7, except that the solvent type. The detailed composition of Example 8 is listed in Table 2 below.

### Example 9

1.0 parts by weight of ethylene vinyl-alcohol copolymer (trade name is 414077, ethylene content is 27 mole % and is available from Sigma-Aldrich, US) was added into 90 parts by weight of solvent consisted of 60 wt % of isopropyl alcohol and 40 wt % of water to form a reaction solution. Then, the reaction was heated to 95° C. for 2 hours until the clear solution was obtained. After that, the clear solution was cooled down to room temperature. Next, 14.4 parts by weight of tetraethoxy silane and 3.6 parts by weight of 3-glycidyloxypropyltrimethoxysilane and the clear solution were mixed uniformly, then 0.2 parts by weight of 37% aqueous hydrochloric acid solution were added thereinto so as to conduct hydrolysis and condensation reactions for 1 hr to form a clear coating solution. Finally, the coating solution was coated on both surface of the polypropylene porous film (trade name is D120D, the film thickness is 20 um and is available from BenQmaterials, Taiwan) to form two composite coating layers thereon. The polypropylene porous film and the composite coating layer thereon are dried in the oven at 80° C. for 3 minutes to obtain a heat-resistant porous separator.

### Comparative Example 1

The separator of the Comparative Example 1 is a single-layer porous polypropylene with a thickness of 20 um. (trade name is D120D, and is available from BenQmaterials, Taiwan)

### Comparative Example 2

The separator of the Comparative Example 2 is a single-layer porous polypropylene with a coating layer including aluminum oxide particles thereon (is available from Vista Advantace Tech., China). The thickness of the single-layer porous separator is 20 um and the thickness of the coating layer is 5 um.

### Comparative Example 3

10 parts by weight of tetraethoxy silane was added into 85 parts by weight of ethanol to form a reaction solution. Then, 10 parts by weight of 1.8% aqueous hydrochloric acid solution was added into the reaction solution so as to conduct hydrolysis and condensation reactions for 1 hr to form a clear coating solution. Finally, the coating solution was coated on both surface of the polypropylene porous film (trade name is D120D, the film thickness is 20 um, and is available from BenQmaterials, Taiwan) to form two composite coating layers thereon. The polypropylene porous film and the composite coating layer thereon are dried in the oven at 80° C. for 3 minutes to obtain a heat-resistant porous separator.

### Comparative Example 4

20 parts by weight of tetraethoxy silane was added into 80 parts by weight of ethanol to form a reaction solution. Then, 10 parts by weight of 1.8% aqueous hydrochloric acid solution was added into the reaction solution so as to conduct hydrolysis and condensation reactions for 1 hr to form a clear coating solution. Finally, the coating solution was coated on both surface of the polypropylene porous film (trade name is D120D, film thickness is 20 um, available from BenQmaterials, Taiwan) to form two composite coating layers thereon. The polypropylene porous film and the composite coating layers thereon are dried in the oven at 80° C. for 3 minutes to obtain a heat-resistant porous separator.

It can be seen from Table 3 that the heat-resistant porous separator of Example 1 to Example 9 all have superior excellent heat-resistant properties. Comparing with Comparative Example 1, the thermal shrinkage ratio of Example 1 to Example 9 are in the range of 10% to 21%. However, the heat-resistance property of Comparative Example 1 is so poor that the thermal shrinkage ratio is about 31.9%.

Moreover, the surface energy of Example 1 to Example 9 are almost larger than 50 dyne/cm², it is considered to have good electrolyte absorption ability properties.

The separator of Comparative Example 1 is a kind of polyolefin separator made from polypropylene. The surface energy is only 34 dyne/cm² so that the surface of the separator is more hydrophobic.

The separator of comparative Example 2 is a polyolefin separator with a coating layer including aluminum oxide particles thereon. It also shows the poor surface energy about 36 dyne/cm² and the surface of the separator is more hydrophobic.

The separators of Comparative Example 3 and Comparative Example 4 are made from propylene with a coating layer including silicon dioxide thereon. The surface energy thereof are both 34 dyne/cm² so that the surface thereof are more hydrophobic.

As a result, comparing with Example 1 to Example 9, the wetting performance of Comparative Example 1 to Comparative Example 4 are poor.

Besides, the air permeability of Example 1 to Example 9 is less than 30 (sec/10 c.c.) and preferably is about 14 (sec/10 c.c.).

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

TABLE 1
The detailed composition and measured data of Example 1 to Example 5

| | | Example | | | | |
|---|---|---|---|---|---|---|
| | | 1 | 2 | 3 | 4 | 5 |
| Porous | type | PP | PP | PP | PP | PP |
| substrate | thickness (um) | 20 | 20 | 20 | 20 | 20 |
| Composite | Ethylene vinyl-alcohol copolymer | 0.5 | 0.6 | 0.2 | 0.7 | 1.5 |
| coating | Tetraethoxy silane | 9 | 2.8 | 3.6 | 5.6 | 7.0 |
| layer | Solvent | 95 | 98 | 98 | 96.5 | 95 |
| | | Ethanol:H₂O = | Ethanol:H₂O = | Ethanol:H₂O = | Ethanol:H₂O = | Ethanol:H₂O = |
| | | 60:40 | 60:40 | 70:30 | 65:35 | 70:30 |
| | Aqueous hydrochloric acid | 0.2 | 0.2 | 0.2 | 0.2 | 0.2 |
| | solution | | | | | |
| | Coating type | Two sides | Two sides | Two sides | Two sides | Two sides |

| | | | | | |
|---|---|---|---|---|---|
| Air permeability (sec/10 c.c) | 18.2 | 14.8 | 14.1 | 15.6 | 15.8 |
| Thermal shrinkage ratio (%) | 11.8 | 20.3 | 21.0 | 14.0 | 11.5 |
| Surface energy (dyne/cm) | >50 | >50 | 48 | >50 | >50 |

TABLE 2
The detailed composition and measured data of Example 6 to Example 9

| | | Example | | | |
|---|---|---|---|---|---|
| | | 6 | 7 | 8 | 9 |
| Porous | type | PP | PP | PP | PP |
| substrate | thickness (um) | 20 | 20 | 20 | 20 |
| Composite | Ethylene vinyl- | 1.5 | 1.0 | 1.0 | 1.0 |
| coating | alcohol copolymer | | | | |
| layer | Tetraethoxy silane | 7.0 | 18 | 18 | 14.4 |
| | 3-glycidyloxy- | | | | 3.6 |
| | propyl- | | | | |
| | trimethoxysilane | | | | |
| | Solvent | 95 | 98 | 98 | 96.5 |
| | | Ethanol: | Ethanol: | Ethanol: | Ethanol: |
| | | H₂O = | H₂O = | H₂O = | H₂O = |
| | | 60:40 | 60:40 | 70:30 | 65:35 |
| | Aqueous | 0.2 | 0.2 | 0.2 | 0.2 |
| | hydrochloric | | | | |
| | acid solution | | | | |
| | Coating type | Two sides | one side | One side | One side |

| | | | | |
|---|---|---|---|---|
| Air permeability (sec/10 c.c) | 30.0 | 26.9 | 15.4 | 15.5 |
| Thermal shrinkage ratio (%) | 10 | 15.4 | 13.0 | 12.3 |
| Surface energy (dyne/cm) | >50 | >50 | >50 | >50 |

TABLE 3
The measured data of Comparative
Example 1 to Comparative Example 4

| | | Comparative Example | | | |
|---|---|---|---|---|---|
| | | 1 | 2 | 3 | 4 |
| Porous | type | PP | PP | PP | PP |
| substrate | thickness (um) | 20 | 25 | 20 | 20 |

| | | | | |
|---|---|---|---|---|
| Coating | | Aluminum | SiO₂ | SiO₂ |
| layer | | oxide | layer | layer |
| | | particles | | |
| Air permeability (sec/10 c.c) | 12.5 | 14 | 14.8 | 18.6 |
| Thermal shrinkage ratio (%) | 31.9 | 21 | 17 | 11 |
| Surface energy (dyne/cm) | 34 | 36 | 34 | 34 |

What is claimed is:

1. A heat-resistant porous separator, comprising:
a porous substrate; and
a composite coating layer coated on at least one surface of the porous substrate, wherein the composite coating layer is an interpenetrating polymer network structure formed by a hydrophilic polymer and silicon dioxide.

2. The heat-resistant porous separator according to claim 1, wherein the porous substrate is made from high density polyethylene, polypropylene, polyvinyl chloride, polyvinyl fluoride, polyester, polyamide or a combination thereof.

3. The heat-resistant porous separator according to claim 1, wherein the silicon dioxide is formed through hydrolysis and condensation reactions of silicon dioxide precursor.

4. The heat-resistant porous separator according to claim 3, wherein the weight ratio of the hydrophilic polymer and the silicon dioxide precursor is in the range of 0.008 to 1.5.

5. The heat-resistant porous separator according to claim 1, wherein the hydrophilic polymer is selected from the group consisting of ethylene vinyl-alcohol copolymer, polyvinyl alcohol and a combination thereof.

6. The heat-resistant porous separator according to claim 1, wherein the composite coating layer further comprises a dispersant.

7. The heat-resistant porous separator according to claim 6, wherein the dispersant is selected from the group consisting of vinyltrimethoxysilane, 3-glycidyloxypropyltrimethoxysilane, 3-aminopropyltriethoxysilane, methacryloyl propyltrimethoxysilane and a combination thereof.

8. A method for manufacturing a heat-resistant porous separator, comprising:
providing a porous substrate;
adding 0.2 to 1.5 parts by weight of a hydrophilic polymer into 90 to 98 parts by weight of a solvent to form a reaction solution;
mixing 1 to 25 parts by weight of silicon dioxide precursor into the reaction solution to form a mixed solution;
adding a aqueous hydrochloric acid solution into the mixed solution to conduct hydrolysis and condensation reactions of silicon dioxide precursor to form a clear solution;
coating the clear solution on at least one surface of the porous substrate to form a composite coating layer; and
drying the porous substrate with the composite coating layer thereon to form a heat-resistant porous separator.

9. The method according to claim 8, wherein the hydrophilic polymer is selected from the group consisting of ethylene vinyl-alcohol copolymer, polyvinyl alcohol and a combination thereof.

10. The method according to claim 8, wherein the solvent is selected from the group consisting of water, ethanol, isopropanol, methanol and a combination thereof.

11. The method according to claim 8, wherein the silicon dioxide precursor is selected from the group consisting of tetraethoxy silane, tetramethoxy silane, trimethoxy silane and a combination thereof.

12. The method according to claim 8, wherein the porous substrate is made from high density polyethylene, polypropylene, polyvinyl chloride, polyvinyl fluoride, polyester, polyamide or a combination thereof.

13. The method according to claim 8, wherein before the step of adding the aqueous hydrochloric acid solution into the mixed solution, further comprises a step of adding a dispersant into the mixed solution.

14. The method according to claim 13, wherein the dispersant is selected from the group consisting of 3-aminopropyltriethoxysilane, methacryloyl propyltrimethoxysilane vinyltrimethoxysilane, 3-glycidyloxypropyltrimethoxysilane, and a combination thereof.
